(19) United States
(12) Patent Application Publication
(10) Pub. No.: US 2018/0033350 A1
(43) Pub. Date: Feb. 1, 2018

(54) DUAL DISPLAY FLAG SYSTEM AND METHOD

(71) Applicant: Bautista Rios, Buffalo, NY (US)

(72) Inventor: Bautista Rios, Buffalo, NY (US)

(21) Appl. No.: 15/613,027

(22) Filed: Jun. 2, 2017

Related U.S. Application Data
(60) Provisional application No. 62/368,175, filed on Jul. 29, 2016.

(51) Int. Cl. G09F 17/00

(52) U.S. Cl. CPC G09F 17/00; G09F 2017/0075; G09F 2017/005; G09F 2017/0033

(57) ABSTRACT

A dual display flag is disclosed herein. The dual display flag includes a banner, and a mount. The banner includes a first-side, a second-side, and a length which define the banner. The first-side is configured to display a first-indicia and the second-side is configured to display a second-indicia, where the first-indicia and second-indicia differ in appearance. The first-indicia and the second-indicia each comprise an identifying symbol for a territory. At least one edge of the banner is structured and arranged to removably affix the banner to a mount, the mount is configured to display the banner. At least one edge of the banner includes an affixer, the affixer configured to affix the dual display flag to the mount.

### CROSS-REFERENCE TO RELATED APPLICATION(S)

The present application is related to and claims priority to U.S. Provisional Patent Application No. 62/368,175 filed Jul. 29, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of signals and indicators of existing art and more specifically relates to flags and flagstaffs.

### RELATED ART

A flag is a piece of fabric with a distinctive design that is used as a symbol, as a signaling device, or as decoration. The term flag is also used to refer to the graphic design displayed, and flags have since evolved into a general tool for rudimentary signaling and/or identification, especially in environments where communication can be challenging. National flags can be patriotic symbols with varied and wide-ranging interpretations, often including military associations or identifications due to their original and ongoing military uses. Flags can also used in messaging, advertising, or for other decorative purposes such as supporting enthusiasm for a sports team or other similar association.

Many United States (or other country) citizens are proud, not only of their country, but also their heritage. Unfortunately, they typically have to choose between flying an American flag or a flag that represents their homeland or heritage. Additionally, state buildings, such as government offices, police and/or fire departments, and others have to install two or more flagpoles for state and/or country flags, which can be a hardship for some communities. Therefore a suitable solution is desired.

U.S. Pat. No. 7,665,412 to Gregg K. Walls relates to a reversible rally flag. The described reversible rally flag includes a flag having a first panel having an outer surface and an inner surface, the first panel bearing a first indicia visible from the outer surface when the flag is turned outside-out, and from the inner surface when the flag is turned inside-out; and, a second panel having an outer surface and an inner surface, the second panel bearing a second indicia visible both from the outer surface when the flag is turned outside-out, and from the inner surface when the flag is turned inside-out; the first and second panels each having a perimeter, the perimeters of the first and second panels substantially secured to one another to form a pouch having a single opening to accommodate turning the flag inside-out.

### SUMMARY OF THE INVENTION

In view of the foregoing disadvantages inherent in the known flags and flagstaffs art, the present disclosure provides a novel dual display flag system and method. The general purpose of the present disclosure, which will be described subsequently in greater detail, is to provide a dual display flag system and method.

A dual display flag is disclosed herein. The dual display flag includes a banner, and a mount. The banner includes a first-side, a second-side, and a length which define the banner. The first-side is configured to display a first-indicia and the second-side is configured to display a second-indicia, where the first-indicia and second-indicia differ in appearance. Preferably the first-indicia and the second-indicia each comprise an identifying symbol for a territory.

At least one edge of the banner is structured and arranged to removably affix the banner to a mount, where the mount is configured to display the banner. Preferably, at least one edge of the banner comprises at least one affixer, with the affixer configured to affix the dual display flag to the mount. The affixer preferably includes a plurality of grommets and additionally includes at least one clip and one cable to display the banner, where the mount includes a flag pole.

In one embodiment, the banner may comprise dimensions larger than five feet by eight feet. In other embodiments, the banner may comprise dimensions smaller than or equal to five feet by eight feet. Also, the banner may be constructed from a water-resistant material. Further, banner may be constructed from a tear-resistant material to provide longevity and durability during use.

According to another embodiment, a method of using a dual display flag is also disclosed herein. The method of using a dual display flag includes a first step, providing a dual display flag, the dual display flag including a banner and a mount; a second step; mounting the banner upon a mount, and a third step, displaying the dual display flag in public view.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dual display flag, constructed and operative according to the teachings of the present disclosure.

FIG. 1 is a front perspective view of the dual display flag during an ‘in-use’ condition, according to an embodiment of the disclosure.

FIG. 2A is a left-side perspective view of the dual display flag of FIG. 1, according to an embodiment of the present disclosure.

FIG. 2B is a right-side perspective view of the dual display flag of FIG. 1, according to an embodiment of the present disclosure.

FIG. 3 is a front perspective view of the dual display flag of FIG. 1, according to an embodiment of the present disclosure.

FIG. 4 is a front view of the dual display flag of FIG. 1, according to an embodiment of the present disclosure.

FIG. 5 is a flow diagram illustrating a method of using a dual display flag, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to flags and flagstaffs and more particularly to a dual display flay as used to improve the ability of a user to display the contents of two flags simultaneously using a single flag.

Generally, a dual display flag enables citizens, business owners, state, and government officials, as well as others, to proudly fly two flags simultaneously. The dual display flag may comprise a dual-sided flag in which one country's flag appears on one side and other countries, states, or other enthusiastic flag appears on the other side. The flag may be offered in assorted sizes to accommodate a standing or mounted flagpole, a vehicle's antenna, or other locations/mountings.

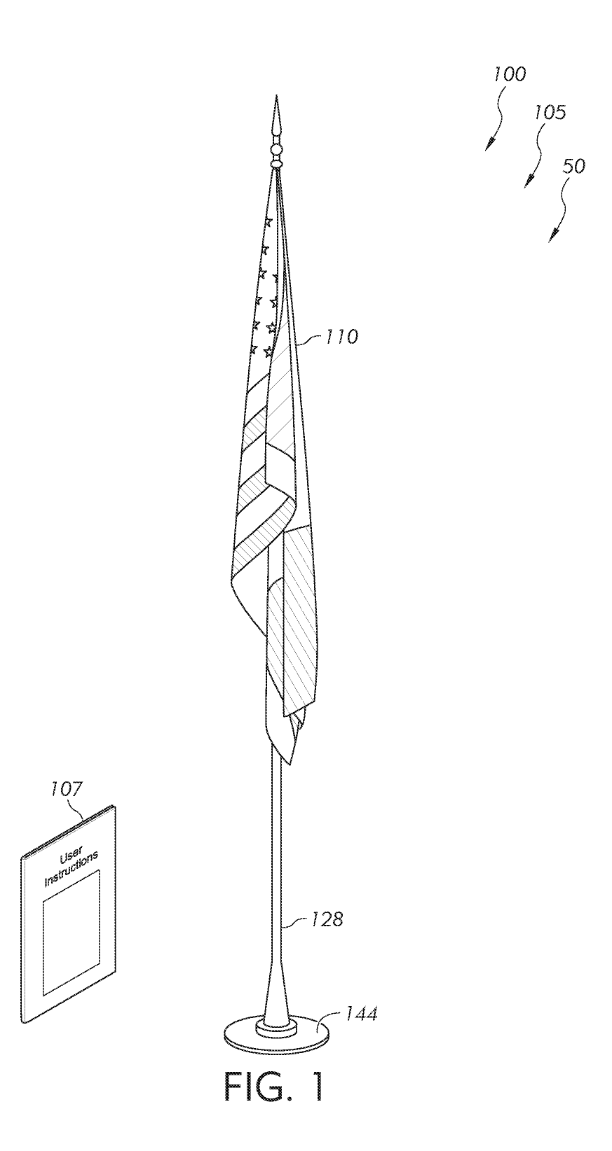

Referring now more specifically to the drawings by numerals of reference, there is shown in FIGS. 1-4, various views of a dual display flag 100.

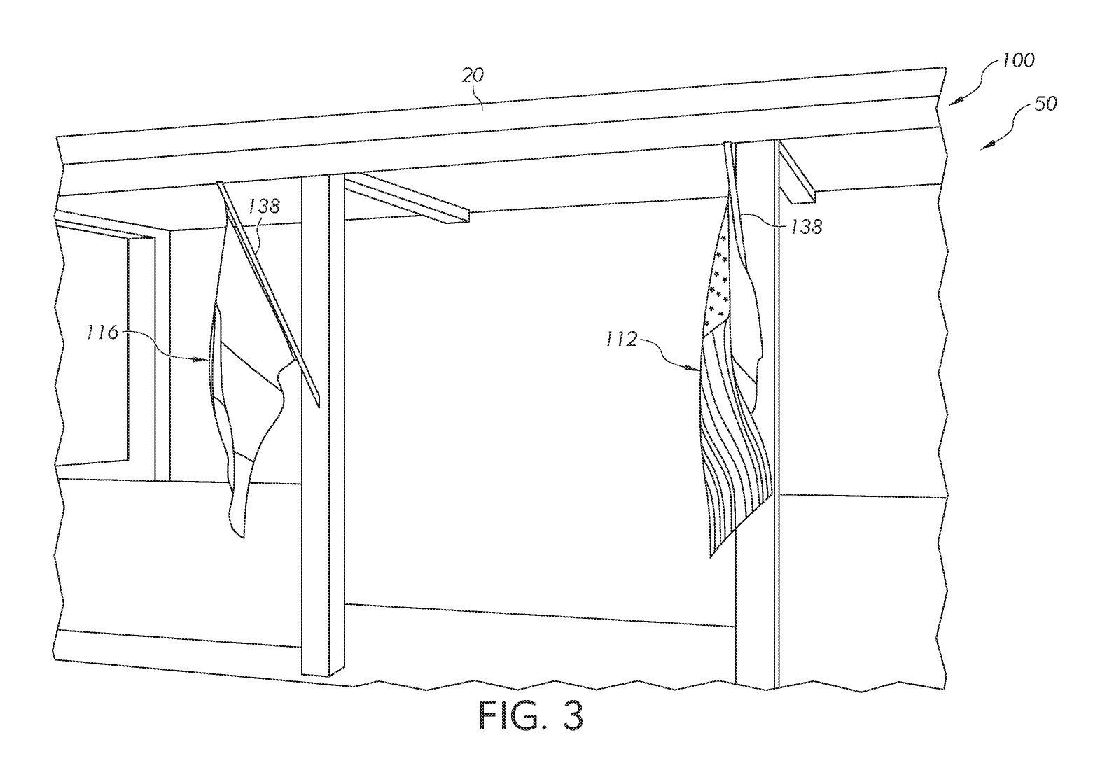

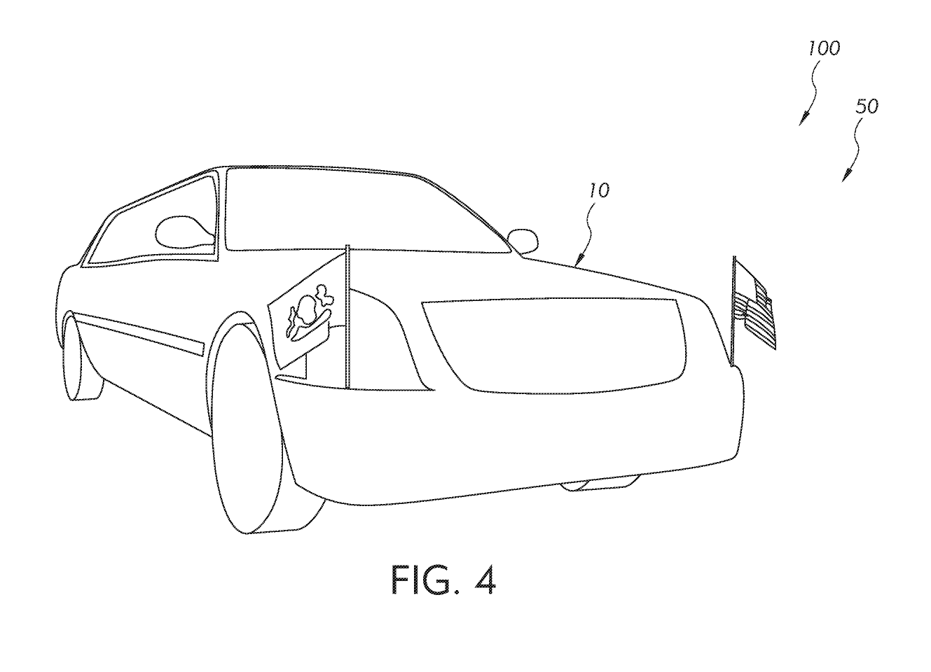

FIG. 1 shows a dual display flag 100 during an ‘in-use’ condition 150, according to an embodiment of the present disclosure (‘in-use’ condition(s) 150 also shown in FIGS. 3-4). Here, the dual display flag 100 may be beneficial for use by a user to display the contents of two different flags on a single flag. As illustrated, dual display flag 100 may include banner 110. As shown, banner may be displayed upon mount 128, where mount 128 may include stand 144.

According to one embodiment, the dual display flag 100 may be arranged as a kit 105. In particular, the dual display flag 100 may further include a set of instructions 107. The instructions 107 may detail functional relationships in relation to the structure of dual display flag 100 such that the dual display flag 100 can be used, maintained, or the like, in a preferred manner.

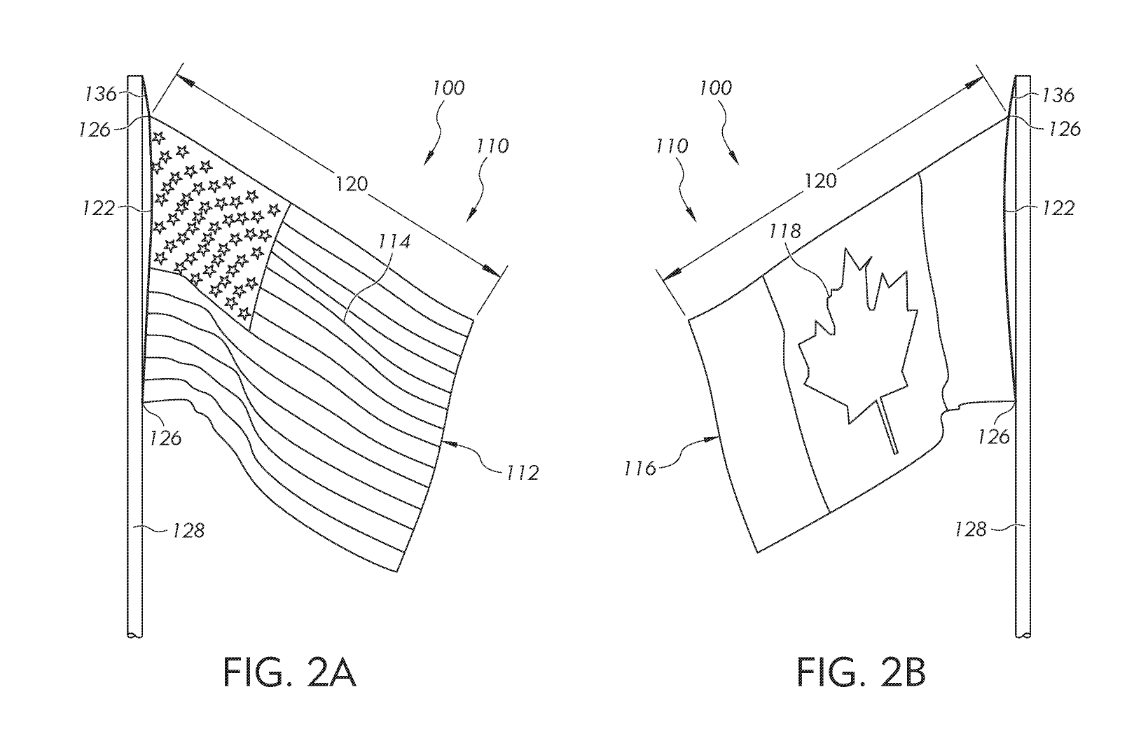

FIG. 2A and FIG. 2B show the dual display flag of FIG. 1, according to an embodiment of the present disclosure. As above, dual display flag 100 may include banner 110. Banner 110 may include first-side 112 configured to display first-indicia 114, second-side 116 configured to display second-indicia 118, and length 120 defining banner 110. As shown, first-indicia 114 and second-indicia 118 differ in appearance. At least one edge 122 of banner 110 may be structured and arranged to removably affix banner 110 to mount 128, mount 128 configured to display banner 110.

At least one edge of banner may include a tassel-fringe. Also, at least one edge of banner 110 may include at least one affixer 126, affixer 126 configured to affix dual display flag 100 to mount 128. Affixer 126 may comprise a plurality of grommets in some embodiments. Other embodiments may include affixer 126 which may be at least one clip (not shown) and alternatively at least one cable 136. Further embodiments may include at least one hook-and-loop fastener (not shown). Additional embodiments may include alternate or multiple affixers 126.

FIG. 3 is a front-perspective view of the dual display of FIG. 1, according to an embodiment of the present disclosure. As shown, mount 128 may comprise flag pole 138 in some embodiments, where flag pole 138 may be free standing (as shown in FIG. 1), or may be affixed to building 20. Other embodiments may comprise mount 128 which may include an antenna for vehicle 10 (as shown in FIG. 4).

First-indicia 114 and second-indicia 118 of banner may each comprise an identifying symbol for a territory, where a territory may include a country, city, state, etc. Also, first-indicia 114 and second-indicia 118 may each comprise a logo identifying a sports team, and/or may comprise an emblem.

Banner 110 of dual display flag 100 may be manufactured in many shapes and/or sizes. In some embodiments banner 110 may include dimensions smaller than three feet by five feet. Another embodiment may include dimensions of banner 110 larger than five feet by eight feet. Other embodiments may include banner 110 with dimensions between three feet by five feet and five feet by eight feet.

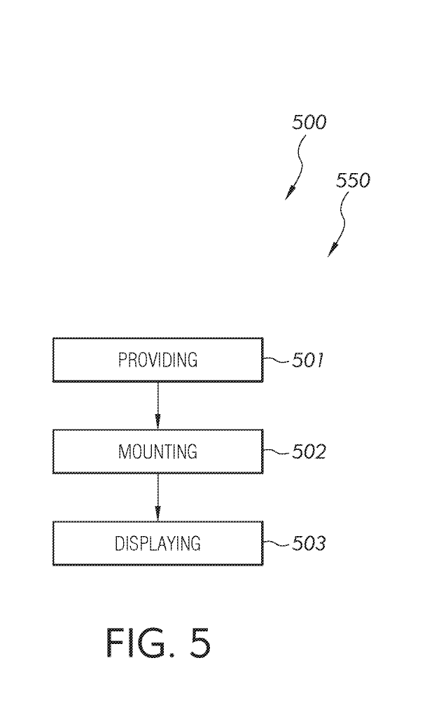

FIG. 5 is a flow diagram illustrating method of using a dual display flag 500, according to an embodiment of the present disclosure. In particular, method of using a dual display flag 500 may include one or more components or features of the dual display flag 100 as described above. As illustrated, the method for method of using a dual display flag 500 may include the steps of: step one 501, providing dual display flag 100, dual display flag 100 including banner 110 and mount 128; step two 502, mounting banner 110 upon mount; and step three 503, displaying dual display 100 flag in public view.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of using a dual display flag. (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dual display flag, said dual display flag comprising:
a banner having a first-side configured to display a first-indicia, a second-side configured to display a second-indicia, and a length defining said banner;
wherein said first-indicia and said second-indicia differ in appearance; and
wherein at least one edge of said banner is structured and arranged to removably affix said banner to a mount, said mount configured to display said banner.

2. The dual display flag of claim 1, wherein said at least one edge of said banner comprises at least one affixer, said affixer configured to affix said dual display flag to said mount.

3. The dual display flag of claim 2, wherein said first-indicia and said second-indicia each comprises an identifying symbol for a territory.

4. The dual display flag of claim 3, wherein said first-indicia and said territory comprises a country.

5. The dual display flag of claim 3, wherein said first-indicia and said territory comprises a state.

6. The dual display flag of claim 2, wherein said first-indicia and said second-indicia each comprises a logo identifying a sports team.

7. The dual display flag of claim 2, wherein said first-indicia and said second-indicia each comprises an emblem.

8. The dual display flag of claim 2, wherein said affixer comprises a plurality of grommets.

9. The dual display flag of claim 2, wherein said affixer comprises at least one clip and alternatively at least one cable.

10. The dual display flag of claim 2, wherein said affixer comprises at least one hook-and-loop fastener.

11. The dual display flag of claim 2, wherein said mount comprises a flag pole.

12. The dual display flag of claim 2, wherein said mount comprises an antenna for a vehicle.

13. The dual display flag of claim 2, wherein said mount comprises a stand.

14. The dual display flag of claim 1, wherein said at least one edge of said banner comprises a tassel-fringe.

15. The dual display flag of claim 1 wherein said banner comprises dimensions between three feet by five feet and five feet by eight feet.

16. The dual display flag of claim 1 wherein said banner comprises dimensions smaller than three feet by five feet.

17. The dual display flag of claim 1 wherein said banner comprises dimensions larger than five feet by eight feet.

18. A dual display flag, said dual display flag comprising:
a banner having a first-side configured to display a first-indicia, a second-side configured to display a second-indicia, and a length defining said banner;
wherein said first-indicia and said second-indicia differ in appearance;
wherein at least one edge of said banner is structured and arranged to removably affix said banner to a mount, said mount configured to display said banner;
wherein said at least one edge of said banner comprises at least one affixer, said affixer configured to affix said dual display flag to said mount;
wherein said first-indicia and said second-indicia each comprises an identifying symbol for a territory;
wherein said affixer comprises a plurality of grommets;
wherein said affixer comprises at least one clip and alternatively at least one cable;
wherein said mount comprises a flag pole;
wherein said banner comprises dimensions larger than five feet by eight feet;
wherein said banner is constructed from a water-resistant material;
wherein said banner is constructed from a flame-resistant material to provide improved safety during use; and
wherein said banner is constructed from a tear-resistant material to provide longevity and durability during use.

19. The dual display flag of claim 17, further comprising set of instructions; and
wherein said dual display flag is arranged as a kit.

20. A method of using a dual display flag, the method comprising the steps of:
providing a dual display flag, said dual display flag including a banner and a mount;
mounting said banner upon a mount; and
displaying said dual display flag in public view.
